(19) United States
(12) Patent Application Publication
(10) Pub. No.: US 2004/0149545 A1
(43) Pub. Date: Aug. 5, 2004

(54) Lettuce and romaine harvesting machine and method

(75) Inventors: Salvadore P. Tarantino, Carmel, CA (US); Robert T. Elliot, Salinas, CA (US); Kevin K. Le, San Jose, CA (US)

Correspondence Address: BEYER WEAVER & THOMAS LLP, P.O. BOX 778, BERKELEY, CA, 94704-0778, US

(73) Assignee: AG Harvesting Technologies, LLC

(21) Appl. No.: 10/691,394

(22) Filed: Oct. 21, 2003

Related U.S. Application Data
(60) Provisional application No. 60/444,729, filed on Feb. 3, 2003.

(51) Int. Cl. B65G 15/44

(52) U.S. Cl. 198/690.2; 198/469.1

(57) ABSTRACT

A produce harvesting apparatus of the invention includes a conveyor system having conveyor belt driven over rollers by a drive element. The belt includes cushioned produce holders suitable for maintaining produce products in a desired orientation on the belt during operation. The apparatus includes a coring station suitable for coring harvested lettuce. The apparatus includes a loading station wherein the cored lettuce is loaded onto the cushioned produce holders and carried to an application station where shelf life extending materials are applied to the cut portions of the lettuce. The processed lettuce then proceeds to an unloading station where it is removed from the conveyor belt. Other inventive aspects include the conveyor belt having cushioned produce holders and the coring station as well as methods of implementing the disclosed devices.

### RELATED APPLICATION

This application claims priority under 35 USC 119(e) from the Provisional Application No. 60/444,729 (Attorney Docket No. AGHTP001P) entitled “LETTUCE HARVESTING MACHINE AND METHOD,” which was filed on Feb. 3, 2003, hereby incorporated by reference.

### TECHNICAL FIELD

The invention described herein relates generally agricultural produce harvesting machines. More particularly, the invention relates to methods and apparatus for “topping” and “coring” agricultural produce products (e.g., lettuce, romaine lettuce, and other similar produce products).

### BACKGROUND

In conventional harvesting of agricultural products, most of the work is done by hand. This leads to a number of problems and inefficiencies that result in the production of less usable agricultural product. These problems are especially pronounced with respect to the harvesting of lettuce and other related leafy produce products. As is known to persons having ordinary skill in the art, lettuce refers to a wide range of lettuce agricultural products. Examples include, but are not limited to, romaine lettuce (also referred to as romaine), red leaf lettuce, green leaf lettuce, butter lettuce, and other lettuce varieties. “Romaine” has an elongated head, with deep green outer leaves and a fresh, slightly yellow center. Romaine is a desirable produce product for a number of reasons, including its high nutrient content. In this application, romaine, leaf lettuce, and other similar agricultural products are referred to generally as “lettuce”.

Conventionally, romaine (and other lettuce products) is harvested by hand in the field. Romaine is “topped” and “cored” by hand in the field. “Topping” is the process of removing the top portion of the leaves of the lettuce. Commonly, a knife is used to cut away the top portion of the romaine. In conventional harvesting the harvester grabs the romaine and holds it firmly in place while cutting away the top with a knife. This process is not delicate and frequently results in bruising and mechanical damage to the romaine.

Additionally, many buyers of lettuce desire their lettuce “cored”. “Coring” is the process of removing the stem and some center portions of the lettuce. A knife is commonly used to cut away the stem and certain undesirable inner portions of the lettuce, thereby coring the lettuce. During coring the harvester grabs the lettuce and holds it firmly in place while he (or she) cuts away the stem and core with a coring knife blade. Again, such a process, as currently practiced, is not delicate and frequently leads to bruising and mechanical damage to the lettuce.

After coring and topping, only the choicest most desirable portions of the lettuce should remain. However, manual coring and topping, as currently practiced, frequently results in excessive amounts of high quality lettuce being discarded due to inaccurate, inconsistent, and excessive topping and coring.

Additionally, lettuce is commonly treated with a chlorine and water solution (or other similar solutions) to reduce the spoilage and undesirable discoloration resulting from coring and topping. However, the current manual spray application of such solutions frequently results in ineffectual and incomplete treatment of the lettuce. Alternatively, current manual processes frequently result in the excessive application of water. Too much water, especially when coupled with mechanical damage and bruising leads to decay, spoilage, and other deterioration of the lettuce product. This problem is frequently worsened by the presence of residual water on the lettuce from the fields where the lettuce is grown.

What is needed is a method and apparatus for coring and cutting lettuce (as well as other like agricultural products) that reduces bruising and mechanical damage during the coring and topping process. Additionally, the method and apparatus should efficiently and effectively be able to apply shelf life extenders onto the cut ends of the lettuce without the excessive application of water. Moreover, embodiments of the method and apparatus can reduce the amount of moisture and residual contamination (dust, dirt, etc.) on the final lettuce product. These and other attributes of the inventive concept will be discussed in greater detail herein.

### SUMMARY

Embodiments of the invention include a produce harvesting apparatus. The apparatus includes a conveyor system for conveying harvested produce between workstations. The conveyor system includes a conveyor belt driven over rollers by a drive element. The belt further including a plurality of cushioned produce holders suitable for holding produce products in a desired orientation on the belt during operation. The apparatus includes a coring station suitable for at least one of coring the produce and topping the produce. The apparatus includes a loading station wherein the produce is loaded having the desired orientation, onto the cushioned produce holders of the conveyor system. The apparatus includes an application station for applying shelf life extending materials onto at least one of a cored portion of the produce and a topped portion of the produce. The apparatus includes an unloading station for removing the produce from the conveyor belt.

Embodiments of the invention include a conveyor belt for use in a produce transport system. Such belt includes a support belt having a plurality of cushioned produce holders arranged thereon. The cushioned produce holders are suitable for holding produce products in place and in a desired orientation on the belt during operation. The cushioned produce holders are configured to limit bruising and damage to the produce products placed on the produce holders.

Embodiments of the invention also include a transport system for conveying produce between workstations. Included in the transport system are a conveyor system including a plurality of cushioned produce holders suitable for holding produce products. The cushioned produce holders are configured hold produce products in place in a desired orientation on the conveyor system as the conveyor system moves the produce products from one workstation to another workstation, and wherein the cushioned produce holders are configured to reduce the amount of damage done to the produce products as they are conveyed on the conveyor system. The transport system includes a loading station for loading produce products into the cushioned produce holders and an unloading station for unloading the produce products from the cushioned produce holders.

Embodiments of the invention further include coring stations for removing a core portion of a produce product. Said coring stations include a base board suitable for having produce products placed thereon and a coring blade shaped for cutting away a core portion of a produce product placed on the base board. The coring station includes a blade mount configured so that the coring blade can be adjustably positioned in order to achieve a desired cut on the produce product in order to cut away a core portion of the produce product.

Another embodiment includes a coring blade for including a knife portion attached to one end of a shaft and a handle attached to the other end of the shaft. The shaft includes a recoil mechanism. The knife portion is configured to cut away an increased proportion of the core portion of the produce product and cut away a decreased portion of the outer portion of the produce product while making a straight cut through the produce product with the coring blade.

Yet another embodiment of the invention comprises a method for harvesting and packaging produce. The method involves harvesting the lettuce. At least one of coring and topping the lettuce is performed. The lettuce is loaded onto the cushioned produce holders of a conveyor system where they are held as they are conveyed to an application station. Shelf life extending materials are applied onto the lettuce, wherein the shelf life extending materials are applied onto a cored portion and a topped portion of the lettuce. The lettuce are unloaded from the cushioned produce holders and packaged.

### BRIEF DESCRIPTION OF THE DRAWINGS

The following detailed description will be more readily understood in conjunction with the accompanying drawings, in which:

FIGS. 1(a)-1(b) are simplified schematic depictions of a produce processing apparatus in accordance with the principles of the invention.

FIGS. 2(a)-2(d) are simplified illustrations depicting an embodiment of a coring station and a resultant cored head of lettuce in accordance with the principles of the invention.

FIGS. 2(e)-2(g) depict embodiments of a portion of a coring blade in accordance with the principles of the invention.

FIGS. 3(a)-3(d) are simplified illustrations depicting various views of an embodiment of an application station for applying shelf life extenders onto a head of lettuce in accordance with the principles of the invention.

FIG. 4(a) is a simplified block diagram illustrating aspects of a produce harvesting apparatus embodiment constructed in accordance with the principles of the invention.

FIG. 4(b) is a perspective view of an embodiment of a conveyor belt constructed in accordance with the principles of the invention.

FIGS. 4(c)-4(h) illustrate various embodiments of produce holders in accordance with the principles of the invention.

FIG. 5 is a simplified perspective depiction of an alternative embodiment of a produce processing apparatus in accordance with the principles of the invention.

FIGS. 6(a)-6(b) schematically depict various views of a cutting and coring station embodiment in accordance with the principles of the invention.

FIG. 7 is a simplified block diagram illustrating aspects of an alternative harvesting apparatus embodiment constructed in accordance with the principles of the invention.

FIG. 8 is depicts an alternative apparatus embodiment including reconfigured conveyor elements and an elevated unloading and packaging station constructed in accordance with the principles of the invention.

It is to be understood that, in the drawings, like reference numerals designate like structural elements. Also, it is understood that the depictions in the Figures are not necessarily to scale.

### DETAILED DESCRIPTION OF THE DRAWINGS

Several example implementations illustrating certain aspects of the present invention are now described with reference to the following drawings. It is expressly pointed out that the following described embodiments are examples only, and are intended to describe, rather than limit aspects of the invention. It is expressly contemplate that the scope of the invention extends beyond the limited examples provided and discussed herein.

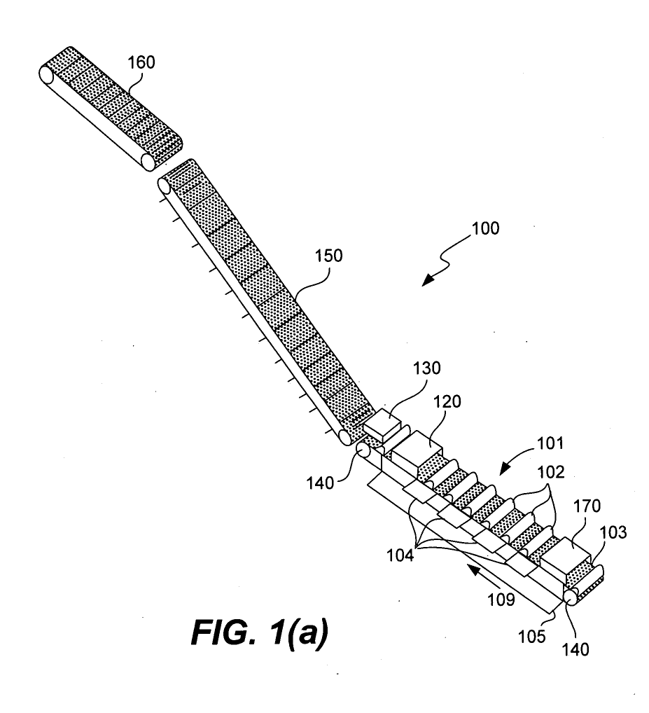

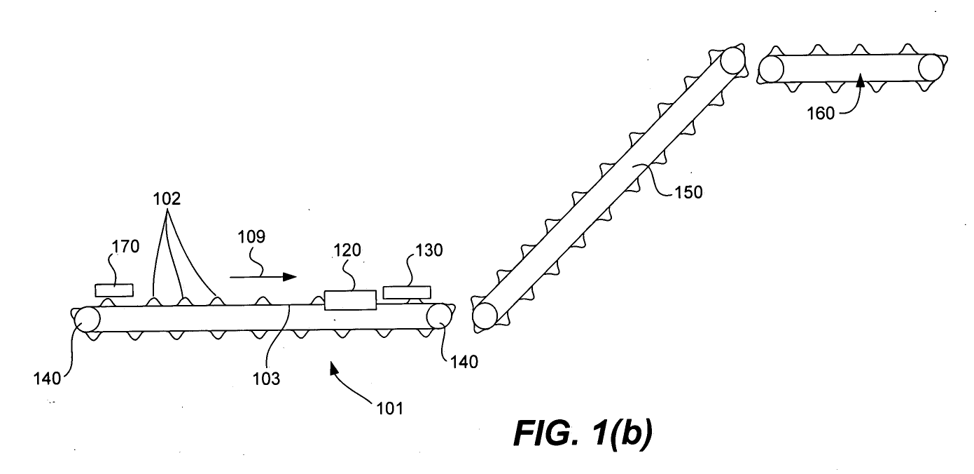

FIGS. 1(a)-1(b) include side and perspective views of an apparatus embodiment of the present invention. The depicted embodiment is a processing machine used, in preferred implementation, to process harvested romaine. The machine includes a conveyor system having a plurality of cushioned produce holders for holding romaine. The depicted apparatus further includes loading stations and coring stations for coring the harvested romaine and loading the romaine onto the cushioned produce holders. The depicted apparatus further includes an application station for applying shelf life extending materials onto the harvested and cut romaine. The apparatus is shown with an optional cleaning station configured to remove excess moisture and debris from the conveyor system. The depicted apparatus is shown with an optional leaf drying station configured to remove excess moisture and debris from the romaine and conveyor system. Optionally, the system can also include a recycling system for recycling excess shelf life extending materials.

FIG. 1(a) is a perspective view depicting a lettuce processing apparatus 100 embodiment in accordance with the principles of the invention. The machine includes a conveyor system having a plurality of cushioned produce holders for holding lettuce. In a preferred, but not exclusive implementation, the conveyor system includes a plurality of conveyor elements 101, 150, 160 arranged to convey produce products from one workstation to another. A first conveyor element 101 comprises an endless belt feed conveyor belt 103 driven around a roller system 140 by a drive device (e.g., a drive motor) so that the objects placed on the belt 103 can be moved in the system. Additionally, in the preferred implementation, the belt 103 includes a plurality of cushioned produce holders. As depicted here, the cushioned produce holders include a plurality of spaced apart cushioned paddles 102 arranged on the belt 103. In the depicted embodiment, the cushioned paddles 102 are spaced apart a predetermined distance such that a head of romaine can fit easily fit between two adjacent paddles 102. Moreover, in preferred embodiments, the paddles 102 are spaced close enough to each other so that a head of romaine placed between the paddles 102 is held substantially together to prevent the head from falling apart as it is conveyed in the apparatus 100. Additionally, in the preferred embodiment, the belt 103 comprises a perforated belt having a multitude of holes running the entire length of the belt 103. The holes allow moisture to easily drain off the romaine placed on the belt 103 as it is conveyed through the system. Other advantages of the perforated belt will be explained in greater detail below.

The depicted embodiment also includes a plurality of coring stations 104 that are positioned along the length of the conveyor element 101. The coring stations 104 facilitate coring of the romaine prior to loading it onto the belt 103. In the depicted embodiment, a coring board 105 runs along the length of the belt 103. In the depicted embodiment, the coring stations 104 are attached to the coring board 105.

In the depicted embodiment, heads of romaine are manually harvested and topped prior to being placed on the conveyor system 101. Coring of these topped heads of romaine is accomplished at the coring stations 104. The coring stations 104 of the depicted embodiment are manual coring stations wherein an individual harvester cores each head of romaine as it arrives at the coring station 104. However, it is specifically contemplated by the inventors that automated coring stations, having automatic alignment and cutting apparatus, can be used to core the heads of romaine. Once the romaine is cored at the coring stations 104, the romaine is loaded between the cushioned paddles where it is moved to other stations of the apparatus 100. Thus, the coring stations 104 also serve as “loading stations” where the cored and topped romaine can be loaded onto the belt between the cushioned produce holders (e.g., the paddles 102) for further transport in the system 100. As the conveyor belt 103 advances (indicated by arrow 109, which indicates the direction that the top surface of the belt 103 moves) the romaine advances toward application station 120 which is used for applying shelf life extending materials onto the romaine. After application of the shelf life extending materials, the romaine can be dried at leaf drying station 130. If desired, additional conveyor elements 150, 160 can be incorporated to further convey the romaine in the system 100. Also, the system 100 can incorporate a cleaning station 170 for cleaning residue and detritus from the belt and produce holders during use.

It is to be noted that the additional conveyor elements 150, 160 can use cushioned produce holders or alternative types of transport modules. For example, FIG'S. 1(a) and 1(b) show conveyor element 150 having more rigid flights that hold the romaine in securely place as it is advanced upward onto another conveyor element 160 that (in this case) does not include either cushioned produce holders or alternative transport modules.

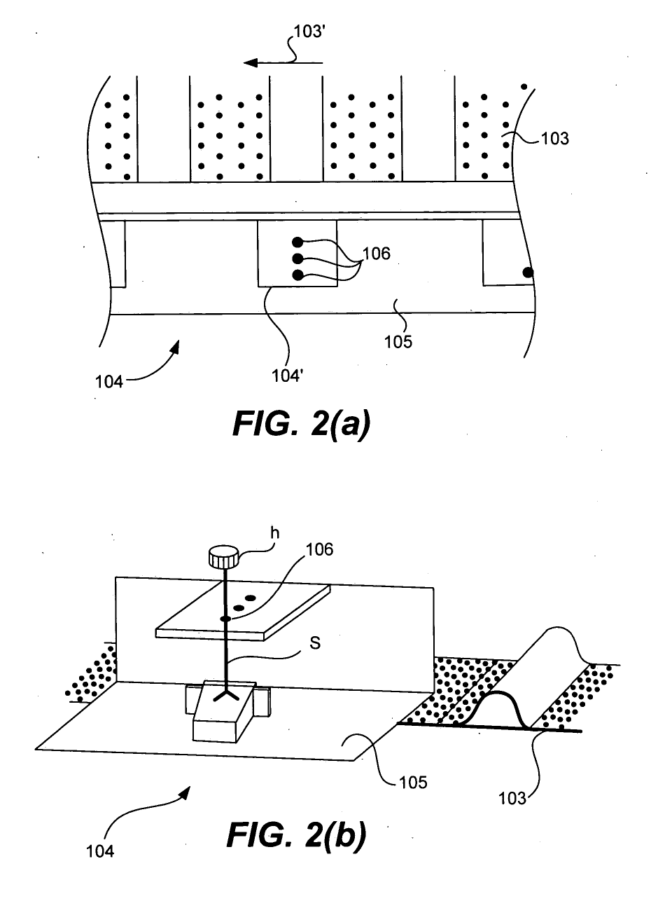

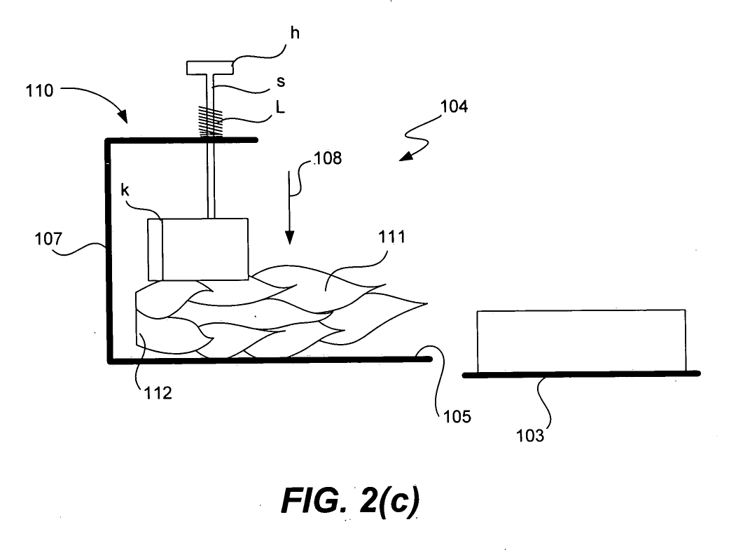

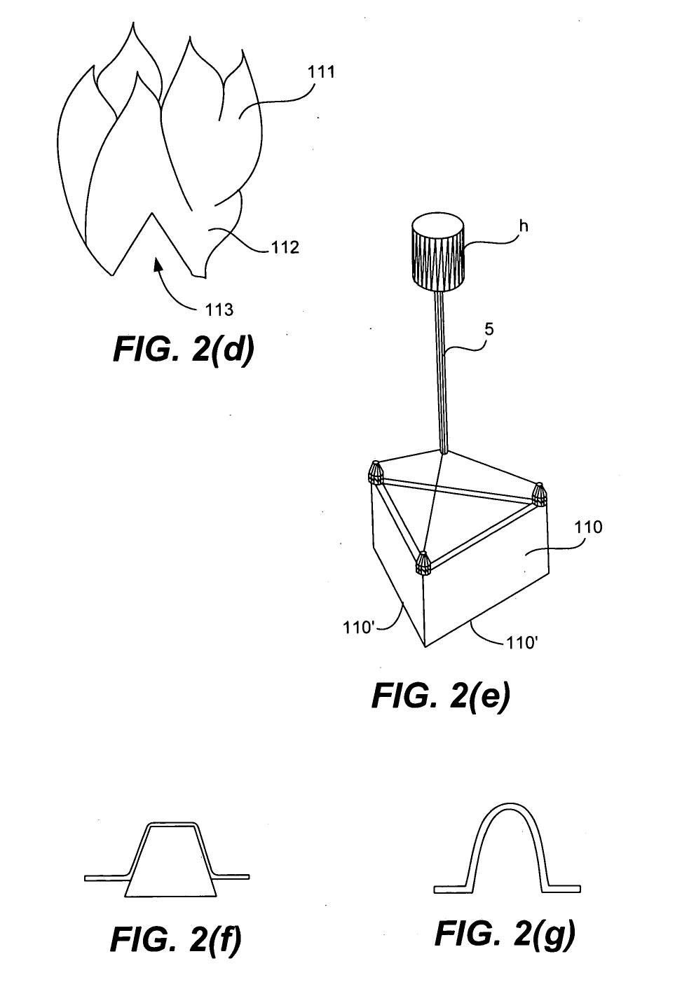

FIGS. 2(a), 2(b), and 2(c) illustrate a manual coring station 104 embodiment in a number of views. FIG. 2(a) is a top plan view of a coring station 104 embodiment. The coring board 105 is typically positioned adjacent to a perforated conveyor belt 103. In the depicted embodiment, a portion of the coring board 105 is shown in position adjacent to a perforated conveyor belt 103 with a plurality of cushioned paddles 102. The arrow 103′ shows a direction of motion for the conveyor belt 103. The depicted coring station 104 includes a coring blade mount 104′ that is used to position a coring blade so that a desired coring cut can be made into a head of romaine. The depicted coring blade mount 104′ includes three openings 106 spaced to provide three different sized cuts. A coring blade can be placed at each different opening 106 to facilitate different cuts. As is well known to persons having ordinary skill in the art, the coring blade mount 104′ can incorporate many different approaches for positioning a coring blade at a desired position.

The perspective view of the coring station 104 embodiment shown in FIG. 2(a) shows that, in preferred embodiment, the coring board 105 of the coring station 104 is positioned slightly above the conveyor belt 103. This facilitates the easy sliding of cored lettuce from the coring station 104 onto the conveyor belt 103. Also shown is a handle portion h of a coring blade with a shaft S portion extending through a desired opening 106.

FIG. 2(c) is a side view of the coring station 104 embodiment shown in FIGS. 2(a) and 2(b). This view can be used to illustrate aspects of operation of the coring station 104. The coring blade 110 is installed in the coring station 104. In the depicted embodiment, the blade 110 includes a handle h that is attached to a sharp knife blade k using a shaft S. The shaft also includes a recoil mechanism L which is depicted here as a spring. In one implementation, the blade 110 operates as follows: the handle h is removed and the shaft s is slide through one of the openings 106 to position the blade 110. The recoil mechanism L is placed to spring load the handle h for easy use. During operation, a head of romaine 111 is placed on the coring board 105 such that the base 112 of the lettuce is flush with a backing portion 107 of the coring station 104. The coring blade 110 is pushed downward (arrow 108) through the romaine 111 cutting away a core portion of the romaine. The recoil mechanism L pushes the blade 110 back upward into the start position. The cored romaine 111 is then placed onto the conveyor belt 103 where it is moved onward for further processing.

FIG. 2(d) depicts a cored piece of lettuce 111 showing a core cut at the base 112 of the lettuce used to remove the core portion 113 of the lettuce. The depicted embodiment shows a substantially V-shaped cut (portion 113) used to remove the core potion 113. Although V-shaped cuts are preferred (due to the ease in blade manufacture) the inventors contemplate that any suitable cut shape (e.g., U-shaped, or a flat cut removing the entire bottom portion of the head of lettuce, as well as other cuts) can be used.

FIG. 2(e) depicts one embodiment of a suitable coring blade. Depicted are the handle h and the corresponding shaft s attached to a coring blade 110. In the depicted embodiment, the coring blade 110 is configured so that a substantially V-shaped core cut will be made in a head of lettuce. Two blade edges 110′ are arranged at an angle from each other to facilitate a substantially V-shaped core cut. Such a V-shaped knife blade is a desirable implementation. A spring can be positioned on the shaft (e.g., as shown in FIG. 2(c) to facilitate spring loading if desired.

Examples of other advantageous knife blade implementations are depicted in the “truncated-V shape” of FIG. 2(f) and the “U-shaped” blade of FIG. 2(g). Each of the depicted knife blades enable a coring blade to remove a substantial portion of a core portion of a romaine head while preserving a substantial portion of the outer leaves, all while using a straight cut of blade through the romaine. As is readily appreciated by those having ordinary skill in the art, such blades are readily applicable to many varieties of lettuce (including without limitation “iceberg” lettuce and other similar leafy lettuce products).

Returning to FIG. 1(a), once the romaine is cored it is placed on the conveyor belt 103. The cored romaine is placed on the cushioned produce holders (e.g., between paddles 102) of the belt 103. In the depicted embodiment, the lettuce is placed between the spaced apart paddles 102 of the belt 103. As the conveyor belt 103 advances (indicated by arrow 109, which indicates the direction that the top surface of the belt 103 moves) the romaine also advances toward application station 120 which is used for applying shelf life extending materials onto the romaine.

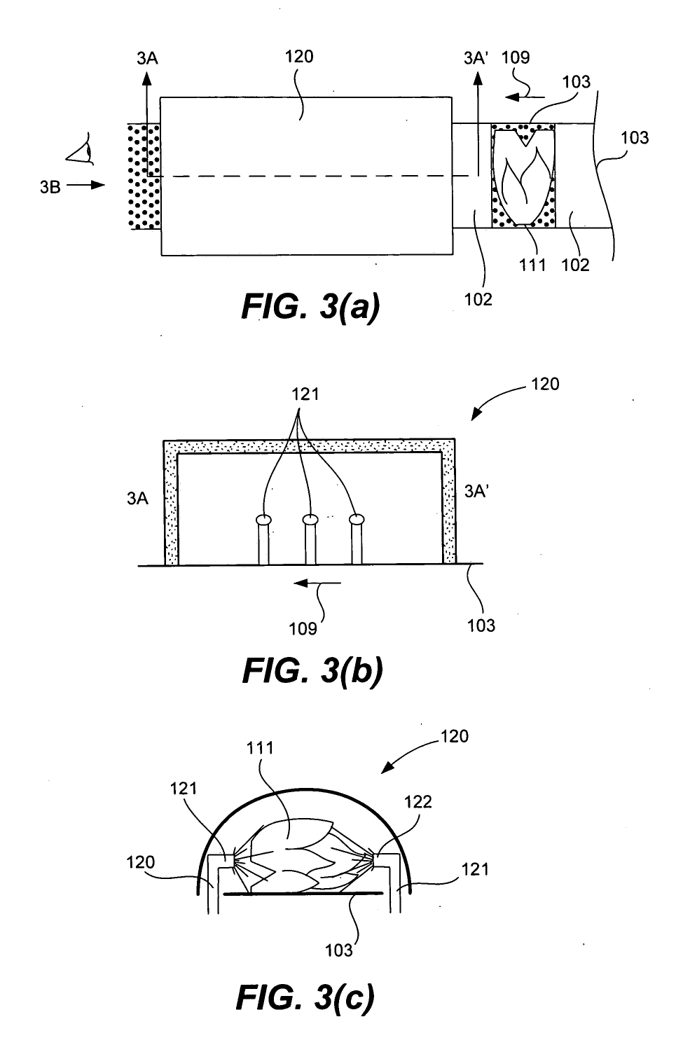

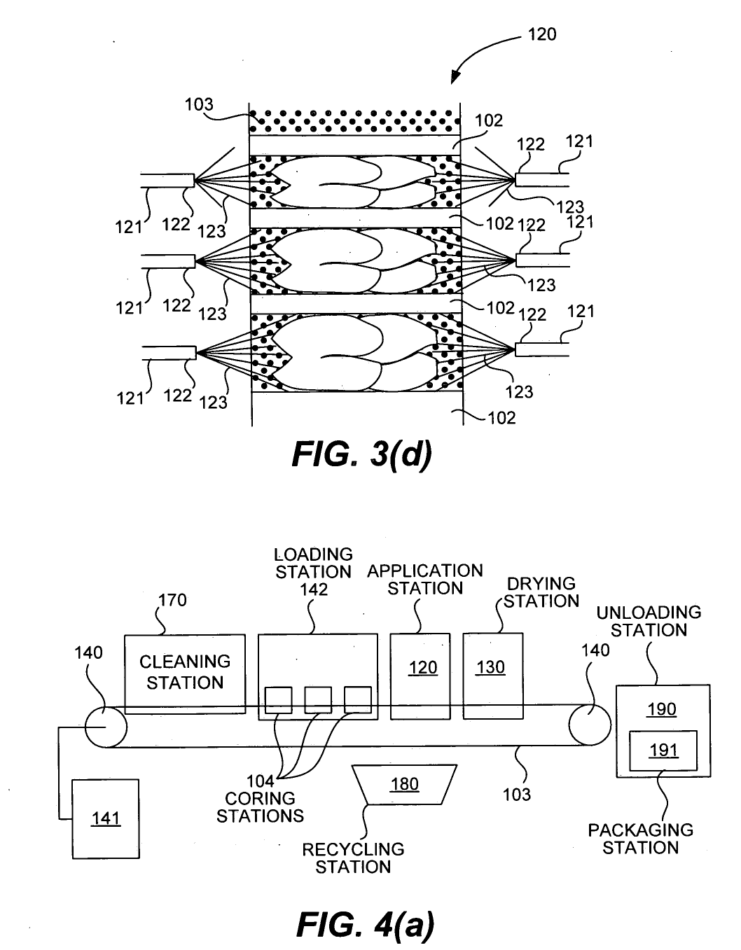

One embodiment of an application station 120 is depicted in FIG. 3(a). FIG. 3(a) is a top down view of a conveyor belt 103 and application station 120. Romaine 111 is positioned on the belt 103 between the cushioned paddles 102. As the lettuce 111 is moved (in direction 109) into the application station 120 shelf life extension materials are applied onto the cut ends of the lettuce 111 (not shown in this view).

Generally, shelf life extenders are used to encapsulate the cut ends of produce products to prevent a wide range of deterioration. For example, the application of shelf life extenders can prevent enzymatic browning, “pinking”, as well as dehydration. Examples, of such shelf life extending materials include, but are not limited to, chlorine and water solutions; water/hypochlorite/salt/starch solutions; water/protein solutions; as well as many others. Another particularly useful type of shelf life extender is a protein/water solution. Importantly, solid shelf life extenders can also be applied to the romaine in solid form (e.g., as an atomized powder). Additionally, such shelf life extenders can be applied as aerosols. The reader is reminded that although disclosed with respect to romaine, the shelf life extending materials discussed herein can be readily applied to other lettuce products as well as related agricultural products.

In preferred implementation, the cut ends of the romaine are well treated with shelf life extenders and the middle (un-cut) portions of the romaine are treated with little or no shelf life extender. In one embodiment, this can be accomplished by applying the shelf life extender directly onto the cut end portions of the romaine. For example, in one implementation, the shelf life extender can be sprayed from directly onto the ends of the romaine in a direction toward the center of the lettuce. In such an embodiment, the shelf life extender can be applied with spray nozzles that spray in a direction substantially parallel to the long axis of the lettuce so that the spray is directly onto the cut ends of the lettuce. Such an application is referred to herein as axial application of the shelf life extending materials. FIG. 3(c) depicts one example of such an application.

FIG. 3(b) shows a cross-section view of the application station 120 embodiment depicted in FIG. 3(a) (the cross-section being taken along 3A-3A′). Lettuce is carried on the conveyor belt 103 into the application station 120 where shelf life extender is applied. In the depicted embodiment, the shelf life extender is in an aqueous solution and is sprayed onto the cut ends of the romaine. In the depicted embodiment, this is accomplished by three sprayers 121 positioned on either side of the romaine. The sprayers 121 are configured so that they spray the shelf life extender onto the ends of the romaine without spraying very much on the middle portions of the romaine.

FIG. 3(c) is an end on view of the application station 120 embodiment depicted in FIG. 3(a) as viewed in direction 3B. The romaine 111 is positioned on the belt 103 so that the cut ends of the romaine face toward the sprayers 121 (or in the case of dry shelf life extender, the dispensers) which spray shelf life extender onto the cut ends of the romaine 111. In the depicted embodiment, the sprayers 121 can include adjustable nozzles 122 that can be adjusted to regulate the volume of shelf life extender sprayed and to reduce the amount of over-spray onto un-cut portions of the romaine 111. The depicted embodiment displays an example of an axially applied shelf life extender. Romaine 111 is positioned so that one end of the romaine (e.g., the cut top) faces one side of the belt 103 and the other end of the romaine (e.g., the cored bottom) faces the other side of the belt 103. In this manner the shelf life extending material can be axially applied from each side. From one side onto the cut top (i.e., by spraying onto the top along the axis of the romaine) of the romaine and from the other side onto the cored bottom (i.e., by spraying onto the bottom along the axis of the romaine) of the romaine so that a minimum of shelf life extender is sprayed onto uncut portions of romaine.

FIG. 3(d) is another view of the application station 120 embodiment depicted in FIG. 3(a). The depicted view is a top down view of a portion of the application station 120 with the top cover removed. The romaine 111 are positioned on the belt 103 lying on their side between the cushioned paddles 102 such that the top of the romaine faces one side of the belt 103 and the bottom of the romaine faces the other side of the belt 103. In this way the paddles 102 gently hold the romaine 111 in place. Moreover, the romaine 111 are positioned so the spray from the sprayers 121 is directed preferentially onto the cut ends of the lettuce while minimizing the over-spray onto the un-cut portions of the lettuce 111. Typically, the cut ends face toward the sprayers 121. In the depicted embodiment, six sprayers 121 are depicted (the actual number being variable) spraying a fan 123 of shelf life extender onto the cut ends of the romaine. As previously described, the sprayers 121 can include adjustable nozzles 122. This is an example of axial application of the shelf life extending materials. The inventors specifically contemplate that embodiments of the application station 120 can include other methods of applying the shelf life extender. Aerosol dispensers, dust applicators, as well as numerous other methods of applying the shelf life extender are contemplated. Moreover, it is specifically contemplated that the shelf life extender can be applied at the application station in a solid form (e.g., as a powder or other like material).

The excess spray and moisture drips off the belt 103 where it is collected by a recycling system (not shown in this view) that filters excess run off for reuse by the system. The use of a perforated belt 103 offers further advantages in that the excess moisture is more easily drained through the belt 103 into the recycling system.

Referring again to FIG. 1(a), after application of the shelf life extender the conveyor belt of the depicted embodiment advances the lettuce to a “leaf drying” station 130. The leaf drying station 130 blows air onto the cored, topped, and treated (with shelf life extender) romaine. This dries excess moisture from the romaine and can be used to remove lingering debris from the lettuce. Also, the blown air of the leaf drying station 130 can be used to dry the belt 103 as well as remove debris from the belt 103. Typically, the leaf drying station 130 comprises a fan arrangement that creates an air flow that is directed onto the romaine as it passes. Additionally, the leaf drying station 130 is not limited to the use of fans to generate air flow, many other air flow devices can be used to direct air onto the romaine. The air flow should be sufficient to remove substantially portions of moisture and debris from the romaine without blowing so hard as to damage the romaine or blow it off the belt 103.

At this point the romaine is ready for further processing. In the embodiment of FIG. 1(a) the romaine is then loaded on to another second conveyor element 150 which elevates the romaine onto a third conveyor element 160 which can convey the romaine to a loading station where it can be unloaded for further processing, packaging, or loading. The inventors specifically contemplate many other further processing approaches and the depicted second and third conveyors elements (150, 160 respectively) are merely one possible implementation.

With further attention to FIG. 1(a), once the belt 103 offloads the lettuce for further processing (e.g., onto conveyor system 150) the belt 103 continues in operation. However, during use the belt 103 becomes quite wet with spray and field moisture. Additionally, quite a bit dirt, lettuce residue, bacteria, and other assorted detritus accumulate on the belt 103 during ordinary usage. Such accumulations have harmful effects of the final produce product. Therefore, what is need is a methodology for cleaning the belt 103. Thus, a cleaning station 170 is used to remove excess moisture and debris from the belt 103 prior to romaine being loaded onto the belt 103. Therefore, the cleaning station 170 reduces the moisture present on the system and thereby reducing the extent of contamination, decay, and microbial growth on the romaine. It is to be noted that the cleaning station is not required to practice the principles of the invention.

However, in the depicted embodiment, the cleaning station 170 blows high pressure air onto the belt 103 to dry excess moisture from the lettuce and remove debris from the belt 103. Typically, the cleaning station 170 comprises a high power fan arrangement that creates an airflow that is directed onto the potions of the belt 130 as they pass. Additionally, the cleaning station 170 is not limited to the use of fans to generate airflow, many other air flow devices can be used to direct air onto the romaine. The airflow should be sufficient to cause significant drying of the belt and remove significant amounts of debris from the belt 103. As before, a high pressure fan system can be used to clean the belt 103. Moreover, other high pressure air systems can be used to clean the belt. In one implementation, the belt 103 is perforated allowing superior airflow through the belt as well as superior drainage. Thus, while not required, embodiments using perforated belts 103 are preferred.

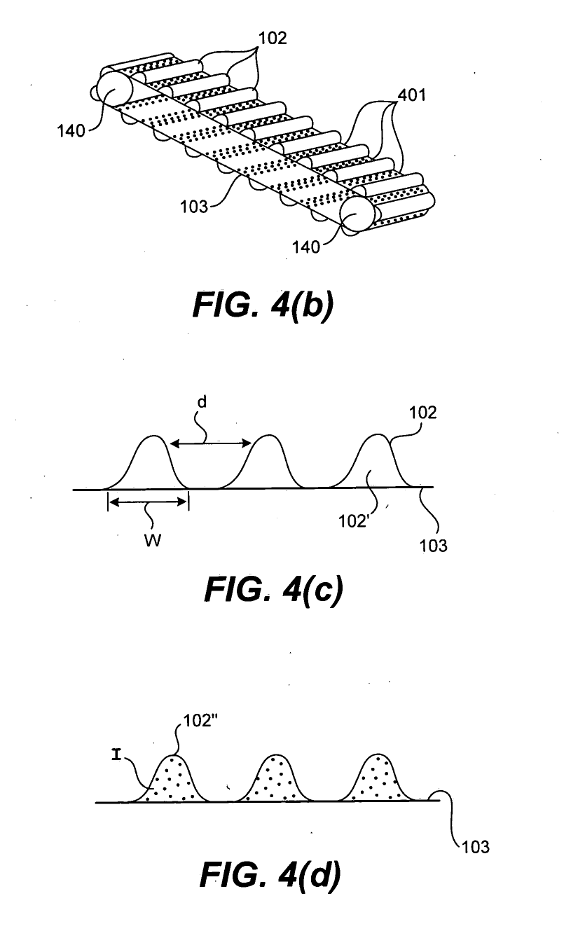

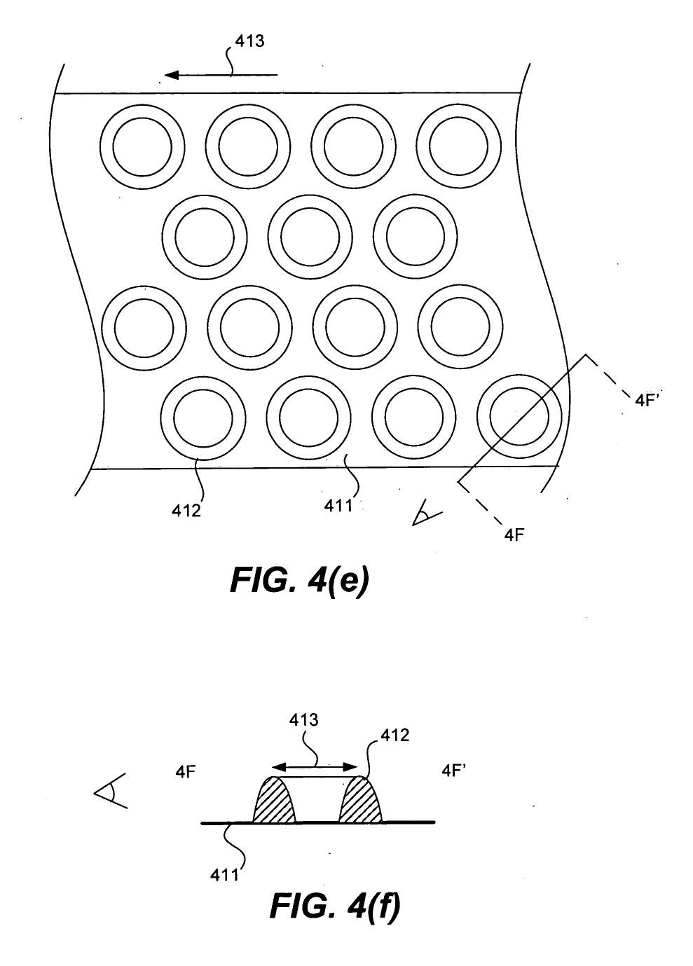

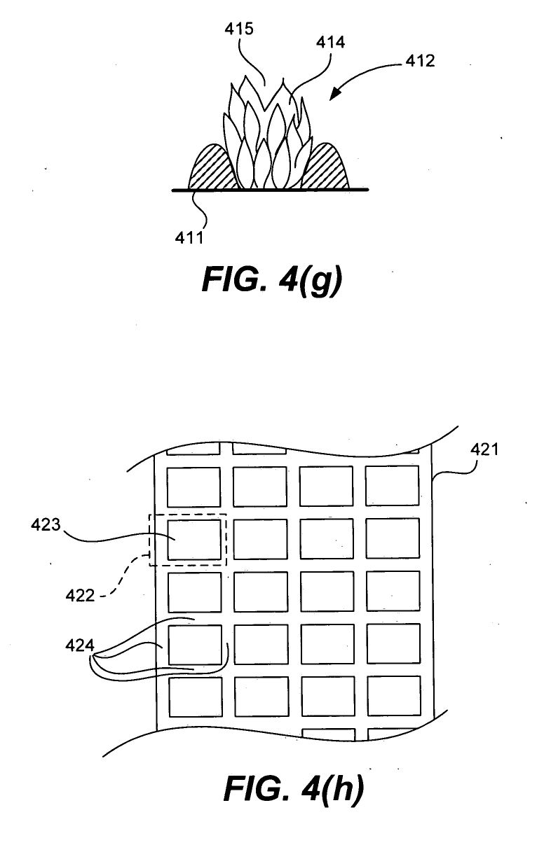

FIG. 4(a) is a block schematic diagram showing a simplified implementation of an apparatus in accordance with the principles of the invention. The depicted embodiment includes a conveyor system having a conveyor element 101 that includes a belt 103 with a plurality of cushioned produce holders for holding produce products (e.g., lettuce and other like produce products). The belt 103 is driven by a drive element 141 over a set of rollers 140 to enable items placed on the conveyor belt to be moved from place to place in a system. The belt 103 passes through a cleaning station 170 configured to remove excess moisture and debris from the conveyor system. The apparatus further includes a loading station 142 for loading produce products onto the belt 103. Typically, the loading station 142 includes a plurality of coring stations 104 for coring the harvested produce products. The produce products are treated with shelf life extending materials at an application station 120. The produce products then pass to a leaf drying station 130 configured to remove excess moisture and debris from the produce and conveyor system. The belt 103 is used to convey the produce products to an unloading station 190 which can include a packaging station 191 for packaging the off-loaded produce. Optionally, the system can include a recycling system 180 for recycling excess shelf life extending materials. It should be noted that all the systems discussed herein (including the drive element 141 for powering the belt 103) can be separately powered (e.g., by motors, generators, or other suitable power sources) or powered by an associated vehicle (e.g., a truck or other like vehicle). Additionally, it is to be noted that the cleaning station 170 and the drying station 130 are not required to practice the invention. Moreover, the schematically depicted belt 103 and drive system (140, 141) can encompass several interconnected belt and drive systems.

An important aspect of the invention is the conveyor system. In particular, embodiments of the invention include an improved belt apparatus having a plurality of cushioned produce holders formed thereon. The cushioned produce holders enable lettuce (as well as other similar produce products) to be set on the belt cushioned by the produce holders so that the damage to the outer leafy portions of the produce is minimized as it is transported from workstation to workstation. FIG. 4(b) is a simplified depiction of a belt 103 in accordance with the principles of the invention. The belt 103 is depicted here as an endless belt 103 driven over a roller system 140 defined by two rollers 140. Persons having ordinary skill in the art appreciated that roller systems having many different rollers, supports, and drive systems can be used in conjunction with the belts of the invention. Belts 103 constructed in accordance with the principles of the invention include a plurality of cushioned produce holders formed thereon. In the depicted embodiment, the cushioned produce holders comprise cushioned paddles 102 which are arranged on a support belt 103 at a spaced apart distance to facilitate the loading of produce products. Additionally, in some embodiments, the belt 103 includes perforations 401 to allow the ready drainage of excess moisture off the belt and produce.

FIG. 4(c) is a side view of a portion of one belt embodiment. The belt 103 includes a plurality of spaced apart cushioned paddles 102. The paddles can be formed of any suitably flexible material. In one embodiment, the paddle 102 is formed of a PET (polyethylene terephthalate) strip about 1/16^{th} of an inch thick In this embodiment, the cushioned paddles 102 comprise a layer of material (e.g., PET) arranged in a bowed configuration to provide padding to the produce products (commonly lettuce) placed between the cushioned paddles 102. The paddles 102 in this embodiments attain some of their cushion by having an empty interior cavity 102′ that allows the paddle 102 to flex when produce rests against it. When the belt 103 is used in romaine harvesting, preferred embodiments of the paddles 102 are spaced apart a distance d of about 2½ inches. Additionally, the paddles 102 have a width w of about 2½ inches. When the belt 103 is used with lettuce (for example, iceberg lettuce), the paddles 102 can be spaced apart a distance d of about 3 inches with the paddle width w still being about 2½ inches. The inventors contemplate that other suitable materials can be used to fashion the paddles 102.

FIG. 4(d) illustrates another paddle embodiment in accordance with the principles of the invention. The depicted embodiment is a side view of a portion of a belt embodiment. The belt 103 includes a plurality of spaced apart cushioned paddles 102″. The depicted paddles 102″ are solid or filled paddles. Such paddles 102″ can be formed of any cushiony material suitable for cradling produce in accordance with the principles of the invention. For example, the surface can be formed of a thin layer of PET and the inside I can be filled with a soft flexible foam material. Alternatively, the paddles 102″ can be one solid mass of flexible material.

In another approach the paddles can be replaced with a plurality of cushioned pads configured to hold lettuce so that a head of cored lettuce does not fall apart and so that the head of cored lettuce can be oriented with the cored portion pointing straight up. One such implementation is disclosed with respect to FIG. 4(e). FIG. 4(e) is a plan view of a portion of a belt 411 having a plurality of annular cushioned pads 412 formed thereon. The arrow 413 indicates a direction the belt 411 moves the lettuce.

FIG. 4(f) depicts a cross-section view 4F—4F′ of a portion of a belt 411 and an annular cushioned pad 412. The belt 411 typically, includes perforations (not shown in these views) for facilitating the easy drainage of moisture from the belt and associated lettuce. In one embodiment, the central interior portion 413 of the cushioned annular pad 412 is about three (3) inches in diameter to facilitate its use with iceberg lettuce. FIG. 4(g) is an illustration of the cushioned annular pad 412 having a head of lettuce 414 placed in the central interior portion 413. The head of lettuce 414 is positioned having its cored portion 415 pointing upward so that shelf life extending materials can easily be applied. The outer leaves of the lettuce 414 are held together by the walls of the cushioned annular pad 412. As the head of lettuce 414 passes through an application station, shelf life extending materials are applied downward (e.g., sprayed or dusted) onto the cut and cored portion 415 of the lettuce 414. As is readily appreciated by those of ordinary skill in the art, the foregoing embodiments can be used with many lettuce varieties as well as with other similar produce products.

In another embodiment, the cushioned pads can be configured a plurality of “squares” arranged to hold lettuce so that a head of cored lettuce does not fall apart and so that the head of cored lettuce is oriented with the cored portion pointing straight up. One such implementation is disclosed with respect to FIG. 4(h). FIG. 4(h) is a plan view of a portion of a belt 421 having a plurality of cushioned pads 422 formed thereon. As with the other embodiments, an open center portion 423 of the cushioned pad 422 is configured so that cushioned pad walls 424 the outer leaves of the lettuce together with the rest of the head of lettuce. As can be appreciated by those having ordinary skill in the art, many other configurations are possible.

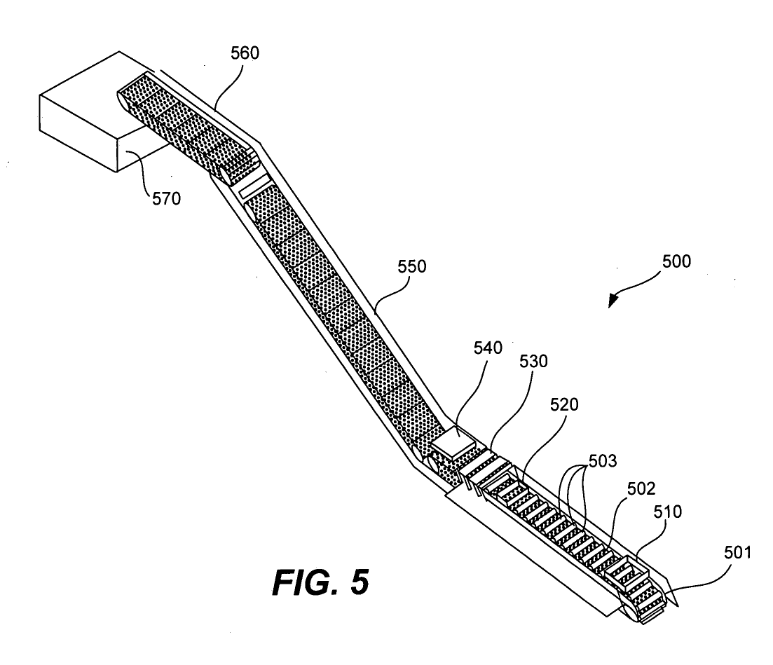

FIG. 5 is a simplified perspective view of another, more automated, embodiment of a harvesting apparatus 500 in accordance with the principles of the invention. The depicted embodiment includes a first conveyor element 501 having a belt 502 with a plurality of cushioned produce holders 503 for holding lettuce. The principles of operation of the first conveyor system 501 and cushioned produce holders 503 are the same as described above. The belt 502 passes through a cleaning station 510 configured to remove excess moisture and debris from the conveyor system. The apparatus further includes a topping and coring station 520 that tops and cores the harvested produce products (e.g., romaine). The topped and cored produce is treated with shelf life extending materials at an application station 530. The topped and cored produce then passes to a leaf drying station 540 configured to remove excess moisture and debris from the lettuce and conveyor system. Optionally, the system can include a recycling system (not shown in this view) for recycling excess shelf life extending materials.

As previously described elsewhere in this specification, the conveyor element 501 comprises a belt 502 having a plurality of cushioned produce holders 503 for holding harvested lettuce. The mode of operation for the may embodiments of the cushioned produce holders 503 has been previously described. The cleaning station 510 is configured to remove excess moisture and debris from the conveyor element. Fan or blower systems are typically but not exclusively used. Such cleaning station 510 is analogous to the cleaning stations described elsewhere in this specification.

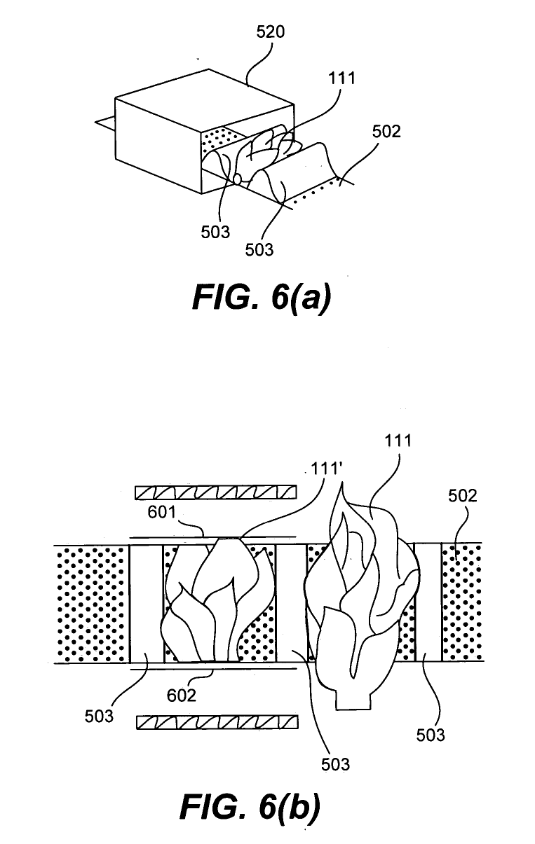

Produce products (e.g., romaine) is harvested in the field in accordance with conventional practices. The heads of, for example, romaine are loaded into the cushioned produce holders 503. Once loaded, the romaine heads are conveyed to a topping and coring station 520 where the top and core portions of the romaine are removed. Reference to FIG. 6(a) shows a head of romaine 111 passing into a topping and coring station 520.

FIG. 6(b) depicts the topping and coring station 520 shown in FIG. 6(a) with the top cover removed to show the interior workings of the station 520. The romaine 111 is loaded on the belt 502 so that (in this case) it is held between paddles 503 where it is conveyed into the topping and coring station 520 by the belt 502. Inside the station 520, two blades 601 and 602 are positioned to remove the top and bottom portions of the romaine 111. A top blade 601 cuts away a top portion of the romaine and a bottom blade 602 cuts away a bottom portion of the romaine (including the core) to produce a topped and cored head of romaine 111′. Thus, the topping and coring of romaine is accomplished in a fully automated manner. The blades 601 and 602 can comprise any number of different blade implementations. In the depicted embodiment, the blades 601 and 602 are band saw blades of a type readily known to persons having ordinary skill in the art.

Referring again to FIG. 5, once romaine has been topped and cored it passes into an application station 530 where it is treated with shelf life extenders. This process is well described elsewhere in the specification. The application station 530 depicted here is also analogous to application stations described elsewhere in the specification. After application of the shelf life extender, the conveyor belt advances the romaine to a “leaf drying” station 540 which dries the cored, topped, and treated (with shelf life extender) romaine. And can also remove lingering debris from the romaine (and belt). Such a leaf drying station 540 and its process of operation are well described elsewhere in the specification. The leaf drying station 540 depicted here is analogous to leaf drying stations described elsewhere in the specification. The leaf drying station 540 can also be mounted on other conveyor elements (e.g., second conveyor element 550) of the apparatus.

At this point the lettuce is ready for further processing. In the embodiment of FIG. 5 the lettuce is then loaded on to another second conveyor element 550 which elevates the lettuce onto a third conveyor element 560 which can convey the lettuce to an unloading station 570 where it is taken off the belts and can be subject to further processing, packaging, or loading. The inventors specifically contemplate many other further processing approaches and the depicted second and third conveyors elements (550, 560 respectively) are merely one possible implementation.

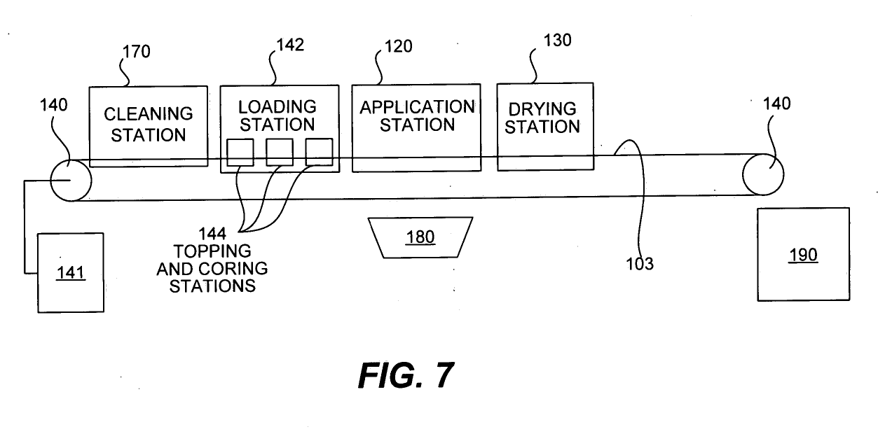

FIG. 7 is a block schematic diagram showing another simplified implementation of an apparatus in accordance with the principles of the invention. The depicted embodiment is somewhat similar to that depicted in FIG. 4(a). The apparatus includes a first conveyor element having a belt 103 with a plurality of produce holders. The belt 103 is driven (using drive element 141) over a set of rollers (shown here as a set of two rollers 140) passes through a cleaning station 170 configured to remove excess moisture and debris from the conveyor element. The apparatus further includes a loading station 142 for loading romaine onto the belt. Additionally, the loading station 142 can include one or more topping and coring stations 144 for topping and coring the harvested romaine. The romaine is treated with shelf life extending materials at an application station 120. The romaine then passes to a leaf drying station 130 configured to remove excess moisture and debris from the romaine and conveyor element. Optionally, the system can include a recycling system 180 for recycling excess shelf life extending materials. It should be noted that all the systems discussed herein can be separately powered (e.g., by motors, generators, or other suitable power sources) or powered by an associated vehicle (e.g., a truck or other like vehicle). Additional conveyor systems can also form part of the apparatus. Once the romaine has been topped and cored the belt 103 carries it to an unloading station 190. Personnel remove the romaine from the belt 103 and package the romaine. To that end, the unloading station 190 typically includes a packaging station 191. For example, the unloading station 190 is arranged so that a team of unloading personnel on the back of a truck can unload the romaine at the unloading station. The packaging station 191 can include a table and packaging boxes for facilitating the sorting and packaging of the romaine into the boxes of other related romaine containers.

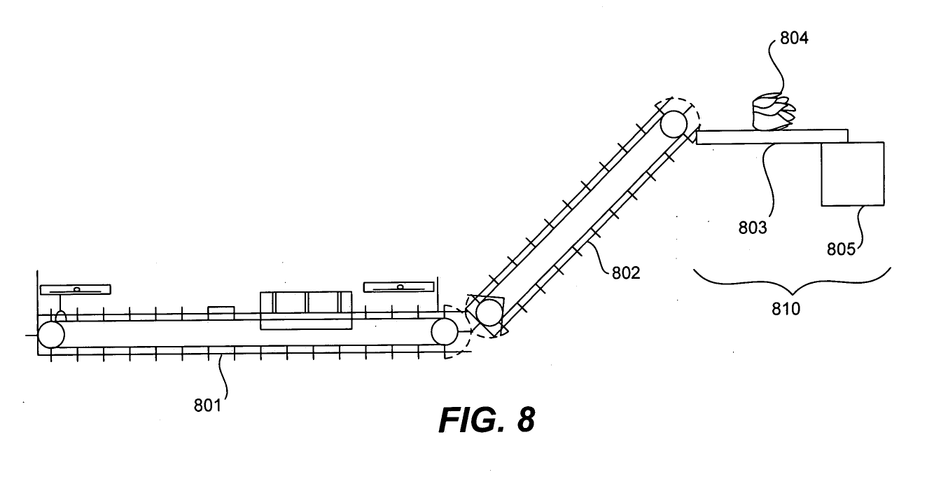

In other implementations, the second conveyor element 150, 550 and third conveyor element 160, 560 that are depicted, for example, in FIGS. 1(a) and 5 can be omitted altogether, reconfigured, or replaced by other conveyor systems to accomplish different implementations. For example, referring to FIG. 8, a first conveyor system 801 of a romaine processing apparatus (for example as depicted and described previously) feeds processed romaine (i.e., topped, cored, and treated with shelf life extenders) to another conveyor element 802. The conveyor element 802 elevates the processed romaine onto an unloading and packaging station 810. In this example, the station 810 includes a table 803 and boxes 805 for loading the processed romaine. The processed romaine 804 is collected on a raised table 803 and put into boxes 805. Conveniently, the raised and filled boxes 805 can be loaded onto a truck for shipping. In some embodiments, the table 803 is positioned on a truck or next to a truck so that the boxes 805 can easily be loaded onto the truck. The table 803 can include box holders that hold the boxes 805 in place while being loaded.

The present invention has been particularly shown and described with respect to certain preferred embodiments and specific features thereof. This invention encompasses a harvesting apparatus as well as belts particularized for use with the apparatus. Moreover, the invention encompasses associated methods for processing produce. It should be noted that the above-described embodiments are intended to describe the principles of the invention, not limit its scope. Therefore, as is readily apparent to those of ordinary skill in the art, various changes and modifications in form and detail may be made without departing from the spirit and scope of the invention. In particular, the inventors contemplate that embodiments of the invention can be used to process produce other than lettuce. Other embodiments and variations to the depicted embodiments will be apparent to those skilled in the art and may be made without departing from the spirit and scope of the invention.

We claim:

1. A conveyor belt for use in a produce transport system, the belt comprising:
a support belt; and
a plurality of cushioned produce holders arranged on the support belt, wherein the cushioned produce holders are suitable for holding produce products in place and in a desired orientation on the belt during operation, and wherein the cushioned produce holders are configured to limit bruising and damage to the produce products placed on the produce holders.

2. The conveyor belt of claim 1 wherein the support band includes a plurality of openings formed therein.

3. The conveyor belt of claim 1 wherein the cushioned produce holders comprise cushioned paddles arranged so that produce products placed between the cushioned paddles are held in place as the belt is in use.

4. The conveyor belt of claim 3 wherein each the cushioned paddles comprise a layer of material arranged in a bowed configuration to provide padding to a produce products placed between the cushioned paddle.

5. The conveyor belt of claim 3 wherein the cushioned paddles are arranged so that romaine produce products placed between the cushioned paddles are held in place in a desired orientation as the belt is in use.

6. The conveyor belt of claim 5 wherein the cushioned paddles are arranged so that the romaine produce products placed between the cushioned paddles are held so that cut ends of the romaine produce products are oriented toward sides of the belt.

7. The conveyor belt of claim 1 wherein the cushioned produce holders include cushioned holding pads arranged on the belt so that produce products placed in the cushioned holding pads are held in place as the belt is in use.

8. The conveyor belt of claim 7 wherein the cushioned holding pads are arranged so that lettuce produce products placed on the cushioned holding pads are held in place in a desired orientation as the belt is in use.

9. The conveyor belt of claim 7 wherein the cushioned holding pads comprise cushioned annular holding pads having an annular shape configured so that produce products placed in an open central portion of the annular holding pads are held in place in a desired orientation as the belt is in use.

10. The conveyor belt of claim 9 wherein the cushioned annular holding pads are suitable for holding an iceberg lettuce product placed in the open central portion of the cushioned pad so that a cut end of the iceberg lettuce product is facing upward from the surface of the belt.

11. A transport system for conveying produce between workstations, the transport system comprising:
a conveyor system including a plurality of cushioned produce holders suitable for holding produce products, wherein the cushioned produce holders are configured hold produce products in place in a desired orientation on the conveyor system as the conveyor system moves the produce products from one workstation to another workstation, and wherein the cushioned produce holders are configured to reduce the amount of damage done to the produce products as they are conveyed on the conveyor system;
a loading station for loading produce products into the cushioned produce holders; and
an unloading station for unloading the produce products from the cushioned produce holders.

12. The transport system of claim 11 wherein the conveyor system includes a conveyor belt including thereon the plurality of cushioned produce holders, the belt being an endless conveyor belt guided over a roller system and being driven by a drive element such that produce products placed in the cushioned produce holders can be conveyed from one workstation to another workstation by the conveyor belt.

13. The transport system of claim 12 wherein the conveyor belts of the conveyor system includes a conveyor belt having a multiplicity of openings formed thereon.

14. The transport system of claim 12 wherein the conveyor system includes a plurality of conveyor belts, each belt including thereon the plurality of cushioned produce holders, each belt being an endless conveyor belt guided over a roller system and being driven by a drive element such that produce products placed in the cushioned produce holders can be conveyed from one workstation to another workstation using said plurality of conveyor belts.

15. An agricultural harvesting apparatus incorporating the transport system of claim 11, wherein the loading station for loading the produce products into the cushioned produce holders includes a plurality of coring stations for coring the produce products; and
wherein the transport system includes an application station for applying shelf life extending materials onto cored portions of cored produce products.

16. An agricultural harvesting apparatus incorporating the transport system of claim 15, wherein the cushioned produce holders of the conveyor system are configured to hold the cored produce products so that the cored portion points upward; and
wherein the application station is arranged so that the shelf life extending materials applied downward onto the cored portions of the cored produce products.

17. An agricultural harvesting apparatus incorporating the transport system of claim 16, wherein the cushioned produce holders comprise annular holding pads configured to hold the cored produce products so that the cored portion of the produce product points upward.

18. An agricultural harvesting apparatus incorporating the transport system of claim 16, wherein the produce product comprises lettuce;
wherein the coring station is suitable for coring lettuce to produce cored lettuce;
wherein the cushioned produce holders are configured to hold the cored lettuce so that the cored portion of the lettuce points upward; and
wherein the application station is arranged so that the shelf life extending materials are applied downward onto the cored portions of the lettuce.

19. An agricultural harvesting apparatus as in claim 15 further including a cleaning station for cleaning the conveyor system and the cushioned produce holders.

20. An agricultural harvesting apparatus as in claim 19 further including a drying station for drying excess moisture off the produce product after they have been treated in the application station.

21. An agricultural harvesting apparatus as in claim 15 further including a recycling station for recycling fluids and shelf life extending materials applied at the cleaning station and the application station.

22. An agricultural harvesting apparatus as in claim 15 wherein the unloading station further includes a packaging station suitable for the unloading of the cored produce product from the cushioned produce holders and packaging the produce product.

23. The agricultural harvesting apparatus of claim 15, wherein the coring stations comprise coring and topping stations suitable for both coring and topping the produce product so that the produce product has a cored portion and a cut top portion; and
wherein the application station is suitable for applying shelf life extending materials onto cored portions of the produce product and onto the cut top portion of the produce product.

24. An agricultural harvesting apparatus of claim 23, wherein the cushioned produce holders of the conveyor system are configured to hold the produce products such that produce product lies sideways on the conveyor system and wherein the cored portion of the produce product points toward one side of the system and wherein the cut top of the produce product points toward another side of the conveyor system; and
wherein the application station is arranged so that the shelf life extending materials are applied from said sides of the conveyor system toward the produce product so that the are shelf life extending materials are applied onto cored portion of the produce product from the bottom of the produce product and applied onto the cut top of the produce product from the top of the top of the produce product.

25. The agricultural harvesting apparatus of claim 24, wherein the cushioned produce holders comprise cushioned paddles arranged in a spaced apart configuration such that produce products placed sideways on the conveyor system between the spaced apart paddles are held on the conveyor system oriented so that the cored portion of the produce product faces toward one side of the conveyor system and so that the cut top of the produce product faces toward another side of the conveyor system.

26. The agricultural harvesting apparatus of claim 25, wherein the produce product comprises romaine;
wherein the coring an topping station is suitable for coring and topping romaine;
wherein the cushioned paddles are suitable for holding cored and topped romaine so that the cored portion of the romaine faces toward one side of the conveyor system and the cut top of the romaine faces toward another side of the conveyor system; and
wherein the application station is arranged so that the shelf life extending materials are applied sideways onto the cored portion of the romaine and applied sideways onto the cut top portion of the romaine.

27. The agricultural harvesting apparatus of claim 15, wherein the produce product comprises harvested romaine and wherein the harvested romaine has been topped in the field;
wherein the coring stations core the topped romaine so that the romaine has a cored portion and a cut top portion; and
wherein the application station is suitable for applying shelf life extending materials onto cored portions of the romaine and onto the cut top portion of the romaine

28. An agricultural harvesting apparatus of claim 27, wherein the cushioned produce holders of the conveyor system are configured to hold the romaine on its side and wherein the cored portion of the romaine points toward one side of the system and wherein the cut top of the romaine points toward another side of the conveyor system; and
wherein the application station is arranged so that the shelf life extending materials are axially applied onto cored portion of the romaine and axially applied to the cut top of the romaine.

29. A produce harvesting apparatus comprising:
a conveyor system for conveying harvested produce between workstations, the conveyor system comprising a conveyor belt driven over rollers by a drive element and having a plurality of cushioned produce holders suitable for holding produce products in a desired orientation on the belt during operation;
a coring station suitable for accomplishing at least one of: coring the produce and topping the produce;
a loading station wherein the produce is loaded, having the desired orientation, onto the cushioned produce holders of the conveyor system;
an application station for applying shelf life extending materials onto at least one of a cored portion of the produce and a topped portion of the produce; and
an unloading station for removing the produce from the conveyor belt.

30. The apparatus of claim 29 wherein the conveyor belt has a plurality of openings formed therein enabling excess moisture to drain off the produce and the belt.

31. The apparatus of claim 29 wherein the cushioned produce holders of the conveyor belt comprise a plurality of cushioned paddles suitable for holding produce products in a desired orientation on the belt during operation.

32. The apparatus of claim 31 wherein the produce products comprise romaine.

33. The apparatus of claim 32 wherein the coring station is suitable for both coring and topping the romaine;
wherein cushioned paddles are configured such that romaine that has been both topped and cored can be placed between the cushioned paddles so that a cored end of the romaine faces one side of the conveyor belt and the topped end of the romaine faces another side of the conveyor belt; and
wherein the application station axially applies the shelf life extending materials from the top of the romaine onto the topped portion of the romaine and axially applies the shelf life extending materials from the bottom of the romaine onto the cored portion of the romaine.

34. The apparatus of claim 29 wherein the cushioned produce holders of the conveyor belt comprise a plurality of cushioned pads suitable for holding produce products on the conveyor belt so that the cored portion of the produce products face upward; and
wherein the application station is configured such that the shelf life extending material is applied downward onto the upward facing cored portions of the produce product.

35. The apparatus of claim 34 wherein the produce products comprise lettuce.

36. The apparatus of claim 35 wherein the cushioned pads comprise annular cushioned pads having a center portion configured so that cored lettuce can be placed in the center portion of the cushioned pads oriented with the cored portion of the lettuce facing upward and wherein the lettuce is held in this orientation until removed.

37. The apparatus of claim 29 further including a cleaning station for cleaning the conveyor system and the cushioned produce holders.

38. The apparatus of claim 37 further including a drying station for drying excess moisture off the produce product after they have been treated in the application station.

39. The apparatus of claim 38 further including a recycling station for recycling fluids and shelf life extending materials applied at the cleaning station and the application station.

40. The apparatus of claim 29 wherein the unloading station further includes a packaging station suitable for the unloading of the cored produce product from the cushioned produce holders and packaging the produce product.

41. A coring station for removing a core portion of a produce product, the coring station comprising:
a base board, suitable for having placed thereon produce products;
a coring blade shaped for cutting away a core portion of a produce product placed on the base board; and
a blade mount configured so that the coring blade can be adjustably positioned in order to achieve a desired cut on the produce product in order to cut away a core portion of the produce product.

42. The coring station of claim 41 further including a backing board positioned so that when a core end of a produce product is placed against the backing board a cut made with the coring blade achieves a desired cut on the produce product and cuts away a core portion of the produce product.

43. The coring station of claim 42
wherein the coring blade includes a knife portion attached to a shaft having a handle and a recoil mechanism;
wherein the blade mount includes a series of openings that lie a progressively greater distances from the backing board;
wherein the shaft passes through one of the series of openings enabling the alignment of the coring blade with the produce product, such alignment enabling the coring blade to achieve a desired cut on the produce product when the coring blade is depressed toward the base board cutting through the produce product to cut away a desired amount of the core portion of the produce product; and
wherein the recoil mechanism is configured to push the coring blade away from the base board once the produce product is cut.

44. The coring station of claim 42 wherein the coring station enables the coring of harvested romaine having a core portion and an outer leafy portion; and
wherein the coring blade is a U-shaped blade to enable a greater portion of core portion of the romaine to be cut away while leaving a greater portion of the outer leafy portion of the romaine in place on the head of romaine.

45. The coring station of claim 42 wherein the coring station enables the coring of harvested romaine having a core portion and an outer leafy portion; and
wherein the coring blade is a truncated V-shaped blade to enable a greater portion of core portion of the romaine to be cut away while leaving a greater portion of the outer leafy portion of the romaine in place on the head of romaine.

46. The coring station of claim 42 wherein the coring station enables the coring of harvested romaine having a core portion and an outer leafy portion; and
wherein the coring blade is a V-shaped blade to enable a greater portion of core portion of the romaine to be cut away while leaving a greater portion of the outer leafy portion of the romaine in place on the head of romaine.

47. A coring and topping station for removing a top portion and bottom core portion of a produce product, the coring station comprising:
a mount positioned such that a produce product can be conveyed through the station; and
a pair of substantially parallel blades positioned in the mount at a predetermined distance from each other so that said blades can cut away a top portion and a bottom portion of a produce product conveyed into the station.

48. A coring blade for using in cutting produce products, the coring blade comprising:
a knife portion attached toward one end of a shaft, the knife portion being configured to cut away an increased proportion of the core portion of the produce product and cut away a decreased portion of the outer portion of the produce product while making a straight cut through the produce product with the coring blade;
a handle attached to another end of the shaft; and
a recoil mechanism mounted with the shaft.

49. The coring blade of claim 48 wherein the knife portion of the coring blade is U-shaped blade thereby enabling an increased proportion of the core portion of the produce product while cutting away a decreased portion of the outer portion of the produce product while making a straight cut through the produce product with the coring blade.

50. The coring blade of claim 48 wherein the knife portion of the coring blade is truncated V-shaped blade thereby enabling an increased proportion of the core portion of the produce product while cutting away a decreased portion of the outer portion of the produce product while making a straight cut through the produce product with the coring blade.

51. The coring blade of claim 48 wherein the knife portion of the coring blade is V-shaped blade thereby enabling an increased proportion of the core portion of the produce product while cutting away a decreased portion of the outer portion of the produce product while making a straight cut through the produce product with the coring blade.

52. A method for harvesting produce comprising:
harvesting lettuce;
performing at least one of coring and topping the lettuce;
loading the lettuce onto the cushioned produce holders of a conveyor system;
holding the lettuce in the cushioned produce holders of the conveyor system;
conveying the lettuce with the conveyor system to an application station;
applying shelf life extending materials onto the lettuce, wherein the shelf life extending materials are applied onto a cored portion and a topped portion of the lettuce;
unloading the lettuce from the cushioned produce holders; and
packaging the lettuce.

53. The method of claim 52, further including cleaning the conveyor system and the cushioned produce holders.

54. The method of claim 52, further including drying excess moisture off the lettuce after they have had shelf life extending materials applied.

55. The method of claim 54, further includes recycling fluids and the shelf life extending materials applied during the applying and cleaning steps.

56. The method of claim 52,
wherein performing at least one of coring and topping the lettuce comprises coring lettuce to remove a portion of the core from the bottom of the lettuce;
wherein loading comprises loading the lettuce onto the cushioned produce holders of the conveyor system so that a cored bottom of the lettuce faces upward; and
wherein applying the shelf life extending materials comprises applying the shelf life extending materials downward onto the cored bottom of the lettuce.

57. The method of claim 56, wherein holding the lettuce in the cushioned produce holders of the conveyor system comprises holding the lettuce so that a cored bottom of the lettuce faces upward in an annularly shaped cushioned holding pad.

58. The method of claim 52,
wherein performing at least one of coring and topping the lettuce comprises coring and topping romaine lettuce to remove a portion of the core from the bottom of the romaine and a portion of the top of the romaine;
wherein loading comprises loading the romaine onto the cushioned produce holders of the conveyor system so that a romaine lies on its side and wherein the cored bottom of the romaine faces toward one side edge of the conveyor system and wherein the top portion of the romaine faces toward another side edge of the conveyor system; and
wherein applying the shelf life extending materials comprises axially applying the shelf life extending materials from the top of the romaine onto the top portion of the romaine and axially applying the shelf life extending materials from the bottom of the romaine onto the cored portion of the romaine.

59. The method of claim 58, wherein holding the romaine in the cushioned produce holders of the conveyor system comprises holding each head of romaine between two cushioned holding paddles.
